(19) United States
(12) Patent Application Publication
(10) Pub. No.: US 2015/0373790 A1
(43) Pub. Date: Dec. 24, 2015

(54) CIRCUIT AND LIGHTING UNIT FOR DIMMABLE LIGHTING APPLICATIONS

(71) Applicant: NXP B.V., Eindhoven (NL)

(72) Inventors: Hendrik Boswinkel, Nijmegen (NL); Leendert van den Broeke, Nijmegen (NL)

(21) Appl. No.: 14/722,972

(22) Filed: May 27, 2015

(30) Foreign Application Priority Data
Jun. 19, 2014 (EP) 14173145.5

(51) Int. Cl. H05B 33/08; H05B 37/02

(52) U.S. Cl. CPC H05B 33/083; H05B 33/0845; H05B 33/0857; H05B 37/0272

(57) ABSTRACT

A circuit and lighting unit for dimmable lighting applications are disclosed, the circuit comprising: a controllable current supply having a positive output and a negative output and being for supplying current to at most one of a first path and a second path, the first and second path each comprising, in use, a series arrangement of a switch and an LED string; the switches each having a respective input, output, and control terminal, the respective inputs being connected in common to a one of the outputs of the controllable current supply, and an open/closed switching status of each switch being selectable by a respective switching signal at its respective control terminal; wherein the second path switch control terminal is electrically coupled to the first path switch output such that the second switching signal is inverted relative to the first switching signal.

### FIELD

This disclosure relates to circuits and lighting units for dimmable lighting applications.

### BACKGROUND

Dimmable incandescent light sources generally have relatively low colour temperatures, at around 2700K for conventional argon bulbs to 3000K for typical halogen lamps at full brightness, and reducing to much lower colour temperatures which may be as low as 1800K for deep dimming levels. It is well known that incandescent sources follow the so-called black-body temperature curve during dimming.

In contrast, modern low high efficiency light sources, such as LED lamps or CFL lamps, generally have an almost constant colour temperature, for example of around 3000K or 3500K, independent of the dimming level.

In many applications, the colour characteristics of incandescent light sources are preferred by the user. As a result, in order to meet this demand, LED light sources have been developed and are becoming available which mimic an incandescent light by using a mixture of LED light sources that emit a different spectral content of light. For each brightness level (set by for example a wall-dimmer or remote control), the mixture is adjusted to mimic an incandescent light source. This solution is generally referred to as “Tuneable White” or “Correlated Colour Tracking”

On the other hand, there are applications—particularly in locations or regions with higher temperatures—for which a high colour temperature is preferred, even at low or deep dimming levels. Moreover, independent control of the intensity and colour of the lighting output may be desirable for scene setting or mood lighting. As a result, it is desirable to have available lamps in which the brightness (or dimming level) and colour temperature can be chosen or set independently, which is not generally possible with “Tuneable White” lamps.

This can be achieved by providing two LED strings with a different colour temperature e.g. 2700K (warm white) and 6500K (cool white) are used for making light with different colour temperatures. The colour temperature is tuned by changing the ratio of the average currents between the two LED strings while keeping the total current constant. Conversely, the brightness is changed by means of changing the total current through the LED strings while keeping the ratio of the currents constant.

In other applications, it may be useful to provide two similar LED strings, mounted so as to have for instance different directionalities, or lensed to focus at different focal points, or provide one “wide spot” and one “narrow” spot light source. Once more, it may be desirable to be able to control the overall brightness independently from the ratios of the two strings—that is to say, the two directionalities or beam spread.

It may be desirable to be able to provide a circuit for such lighting applications, which requires only a single driver circuit, in order to keep the bill of material costs down.

### SUMMARY

According to a first aspect of the present disclosure, there is provided a circuit for dimmable lighting applications, the circuit comprising: a controllable current supply having a positive output and a negative output and being for supplying current to either a first path or a second path, the first and second path each comprising, in use, a series arrangement of a switch and an LED string; the first path switch and the second path switch each having a respective input, a respective output and a respective control terminal; the respective inputs being connected in common to a one of the positive output and the negative output of the controllable current supply, and an open/closed switching status of each switch being selectable by a respective switching signal at its respective control terminal; wherein the second path switch control terminal is electrically coupled to the output of the first switch such that the second switching signal is inverted relative to the first switching signal.

Thus according to this aspect, current may be switched between the first and second string without requiring an independent or separate inverter component, since the first path switch may provide a dual function of switch and inverter. Thereby it may be possible to avoid the costs and/or circuit complexity associated with a separate inverter. Generally in such circuits it is preferred to direct current through at most only one of the current paths at any one time, in order to avoid high dissipation due to differences in load output voltages (which would generally be the case with two LED strings operating at different average current or LEDs that are of different type), and using the first switch to additional provide inverter functionality function may ensure that this occurs.

Typically, the respective input of the first and second path switches are connected in common to the negative output of the current supply. Such a configuration generally enables low-side switches, which may be less expensive or more readily available than high side switches which would typically be required in embodiments in which the respective input of the first and second path switches are connected in common to the positive output of the current supply.

Typically, the controllable current supply is configured to be powered from a mains supply. “Use” refers to use of the circuit in a dimmable lighting application.

In one or more of the embodiments in which the respective inputs are connected in common to the negative output of the controllable current supply, the circuit further comprises a pull-up resistor electrically connecting the second path switch control terminal to the controllable current source positive output. A pull-up resistor may ensure that the voltage at the control terminal is sufficient to close the second path switch when required. In one or more of the embodiments in which the respective inputs are connected in common to the positive output of the controllable current supply, the circuit further comprises a pull-down resistor electrically connecting the second path switch control terminal to the controllable current source negative output. In other embodiments the circuit further comprises a voltage divider electrically connecting the second path switch control terminal to first and second current supply output terminals. A voltage divider may have a similar effect, by fixing the voltage of the second path switch control terminal relative to the voltage of the current supply, provided that the voltage is not pulled to a different level—for instance by being connected to the switched output of the first path switch when that switch is closed.

In one or more embodiments the second path switch control terminal is electrically coupled to the switched output of the first switch by a blocking diode. That is to say there is a blocking diode which electrically connects the second path switch control terminal to the switched output of the first switch.

The blocking diode may ensure that the voltage on the control terminal of the second switch is sufficiently low to ensure the switch does not get damaged due to overvoltage, which might occur if the voltage across the LEDs in the first string is low. This may be particularly useful in embodiments in which the switches are implemented as bipolar transistors, since the Schottky diode may prevent first path LED string current from flowing via the base-emitter junction of the bipolar transistor in the second path. In other embodiments, the second path switch control terminal is directly connected to the switched output of the first switch.

In one or more embodiments the first path switch and the second path switch each comprise a bipolar transistor, and the blocking diode may be a schottky diode. The forward voltage of a schottky diode is smaller than the base-emitter voltage of the typical, NPN, type of bipolar transistor. Without limitation, in other embodiments the first path switch and the second path switch may be implemented as MOSFETs. MOSFETS generally draw low (or negligible) gate current in comparison with the base currents drawn by bi-polar transistors during operation.

In one or more embodiments at least one of the first and second path is arranged to further comprise, in use, a capacitor arranged in parallel with the respective LED string. In one or more embodiments at least one of the first and second path further comprises a diode in the series arrangement.

In one or more embodiments the circuit further comprises a microcontroller configured to provide at least one of the first switching signal and an average current supply control signal. Provision of a microcontroller in the circuit may enable flexibility of control. In embodiments in which the circuit is supplied from a phase-cut mains supply, the average current supply control signal may be derived by the microcontroller from the phase-cut angle.

In one or more embodiments the microcontroller is configured to control the current supply by pulse width modulation. In such embodiments, there will be periods during which the controller current supply is supplying current to neither the first current path nor the second path. In other embodiments, the controllable current source may provide a continuous current output having a variable or controlled level. In such embodiments, the microcontroller may provide the signal indicating the current output level which may be continuous and directed at any moment to either the first path or the second path.

The circuit may further comprise an optocoupler arranged between the first switch control terminal and the microcontroller for isolating the first switch control terminal therefrom. Such an optocoupler may provide isolation of the LEDs from the supply, which may be particularly useful where the supply is a mains supply. In other embodiments isolation of the LEDs from mains and may not be required.

In one or more embodiments the microcontroller is configured to receive a colour temperature control signal, and to determine the first switching signal in dependence on the colour temperature control signal. In other embodiments, particularly those in which the ratio of the LED strings is not utilised to vary the colour, but for instance to vary the relative intensity of light output between two directions, the signal received by the microcontroller may be a relative intensity signal, or other appropriate signal.

In one or more embodiments the microcontroller comprises a wireless receiver configured to receive at least the colour temperature control signal wirelessly. This may enable remote control of the colour temperature independent of the intensity level. Similarly in embodiments in which the first control signal is not for colour control, the microcontroller may wirelessly receive an appropriate signal from which the first control signal is derived.

In one or more embodiments the controllable current supply is configured to be powered from a mains supply. The mains supply may be phase-cut dimmed;

however the disclosure is not limited thereto, and in embodiments the circuit may be configured for use with an undimmed mains supply. In such embodiments the microcontroller may receive, for example it may wirelessly receive, both the first control signal and the average current supply control signal

In one or more embodiments, the controllable current supply comprises a power supply and the microcontroller is configured to be powered from the power supply. In other embodiments, the microprocessor may be separately powered, for instance by a battery or by a photovoltaic supply

In one or more embodiments, the circuit further comprises an LED string in each of the first and second path. The LED strings may operate with equal or unequal voltages, and may have the same or different number of LEDs. An LED string may be a single LED.

According to another aspect of the present disclosure, there is provided a lighting unit comprising a circuit described above, housed in a luminaire.

These and other aspects of the invention will be apparent from, and elucidated with reference to, the embodiments described hereinafter.

According to a further aspect, there is provided a circuit for dimmable lighting applications, the circuit comprising: a controllable current supply for supplying current to either a first path or a second path; the first and second path each comprising a series arrangement of a switch, a diode, and a capacitor, and configured for connection of an LED string in parallel with the capacitor; wherein each switch has a respective input, switched output and control terminal, wherein each switch is configured to switchable connect its input to its output to enable current through the respective first or second path in response to a first or second switching signal respectively on its control terminal; wherein the second control terminal is electrically connected to the output of the first switch such that the second switching signal is inverted relative to the first switching signal.

### BRIEF DESCRIPTION OF DRAWINGS

Embodiments of the invention will be described, by way of example only, with reference to the drawings, in which

FIG. 1 shows, schematically, a lighting circuit in which current is switched alternately between two LED strings;

FIG. 2 show an implementation of the concept of FIG. 1, using an inverter;

FIG. 3 shows an implementation of the concept of FIG. 1, in which just one of the strings is actively switched;

FIG. 4 shows, schematically, an isolated flyback light circuit according to embodiments;

FIG. 5 shows an implementation of a circuit according to FIG. 4;

FIG. 6 shows an implementation of a circuit comprising a non-isolated flyback circuit according to embodiments;

FIG. 7 shows an implementation of a circuit comprising a non-isolated buck circuit according to embodiments;

FIG. 8 shows various waveforms for a lighting circuit according to embodiments operating with PWM dimming;

FIG. 9 shows the waveforms of FIG. 8 over a longer time period;

FIG. 10 shows various waveforms for a light circuit according to embodiments, operating with analogue dimming, over the longer time period; and FIG. 11 shows another implementation of a circuit according to embodiments.

It should be noted that the figures are diagrammatic and not drawn to scale. Relative dimensions and proportions of parts of these figures have been shown exaggerated or reduced in size, for the sake of clarity and convenience in the drawings. The same reference signs are generally used to refer to corresponding or similar features in modified and different embodiments

### DETAILED DESCRIPTION OF EMBODIMENTS

There are several possible ways to make a LED lamp with two LED strings in which the currents and current ratio through the LED strings can be controlled independently, assuming for the moment that the lamp is powered from an alternating current (AC) supply, and only a single AC/DC converter is utilised:

Firstly, one AC/DC converter with a voltage output may be followed by two linear regulators to control the LED currents. However, in order to accommodate differences in string voltage, the linear regulators must be oversized and will get hot since these differences in string voltage are directly translated into losses in the linear regulators. Since the voltage tolerance of LED strings is typically +/−10% and the voltage varies with temperature and current, these losses may be unacceptable.

Next, the dissipation problem in the above situation may be solved by replacing the linear regulators by DC/DC switch mode regulators including an inductor. Each DC/DC converter controls the current in one of the strings. But switch mode regulators are more expensive than the linear regulators. So this option is generally likely to be uneconomic.

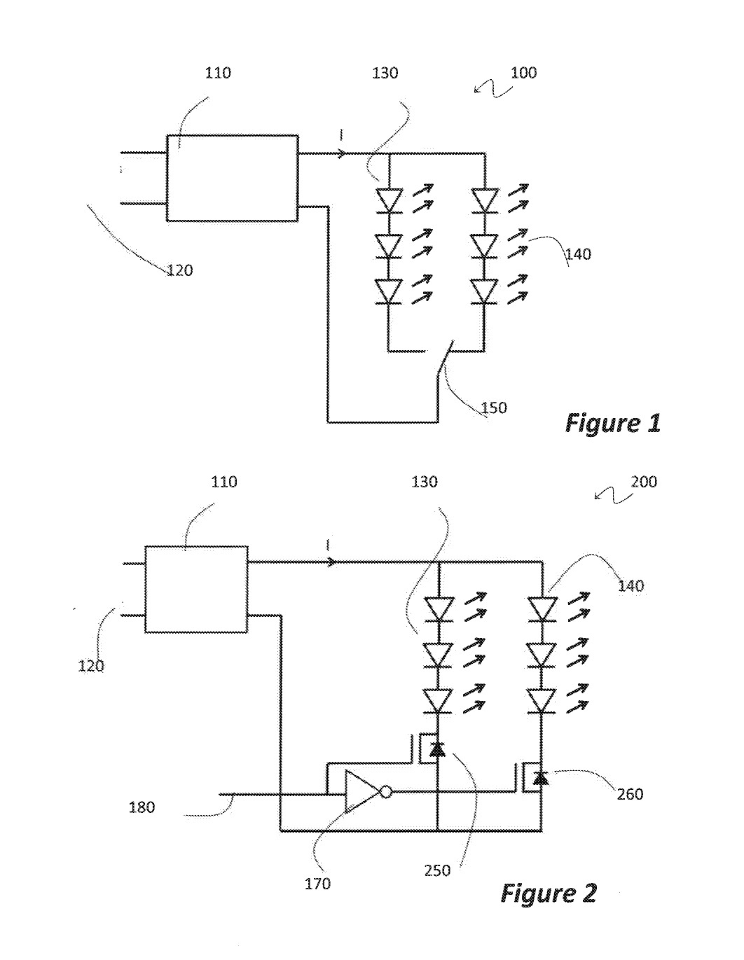

Thirdly, a single AC/DC converter may be used having current output. The current is switched alternately between the two LED strings. Now the colour temperature is changed by changing the duty cycle. Such a solution may involve low costs and may have low losses. FIG. 1 shows, schematically, such a concept. A lighting circuit 100 comprises an AC/DC converter 110, which is supplied by an AC mains input 120. Unless the circuit is operating at full brightness, the AC mains input will generally be phase cut, with either a leading edge or trailing edge phase-cut waveform. Two strings of LEDs, 130 and 140, are arranged generally in parallel, and the current from the AC/DC converter 110 is switched between them by means of a switch 150. The fraction of the average current which goes through each LED string 130, 140, is determined by the fraction of time that the current is switched to that specific string.

One possible implementation of such as circuit, using an inverter IC, is shown in FIG. 2. In circuit 200 current is allowed to flow through each string 130 and 140 by closing respective switch 250 and 260. A drive signal 180 directly drives the control terminal of switch 250, and indirectly drives the control terminal of switch 260, through inverter 170. The inverter ensures that at any time one and only one switch is closed, with the result that the current is toggled between the two LED strings under control of the drive signal 180. However, using an inverter IC may not be desirable, since it requires a supply voltage (resulting in additional components and thus likely additional cost). Also, the IC would generally be required to operate at high temperatures inside a lamp. As a result a high temperature compatible IC, such as a 125° C. compliant IC, may need to be used.

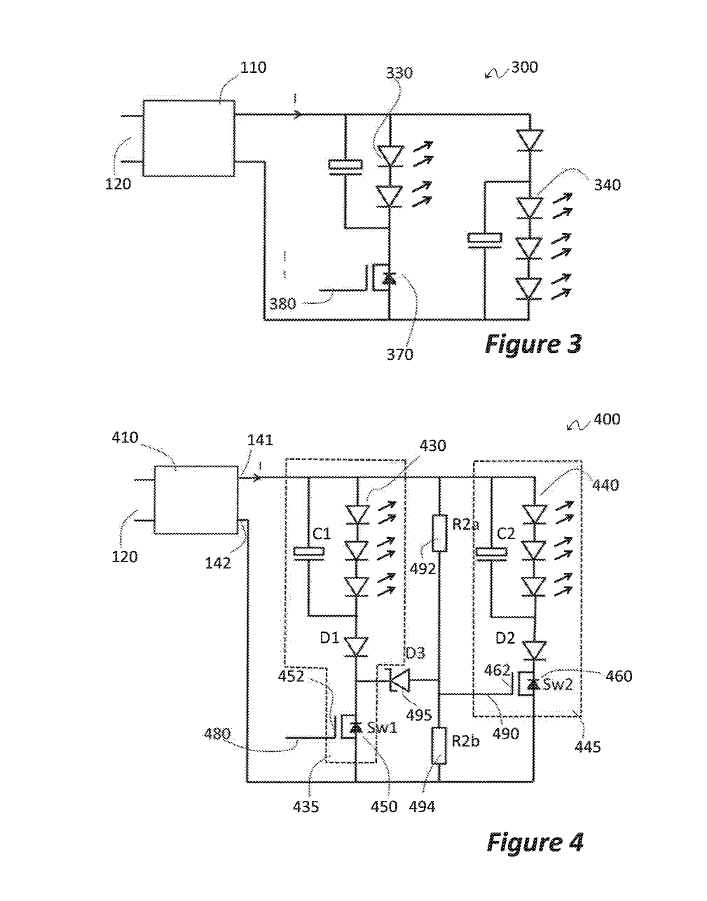

Another, way of toggling current between two LED strings is illustrated by the circuit 300 shown in FIG. 3. In this method the LED string 330 with the lower voltage (which is shown, for illustration purposes only, as a string of two LEDs) is actively switched by the drive signal 380 for switch 370. If this LED string is conducting, then the voltage across the second LED string 340 is below its threshold voltage and therefore does not conduct current. So the tolerances of the LED string forward voltage must be taken into account in the design. The production tolerance of the LED string voltage is typically between 10% and 20%. The forward voltage of a LED string also depends on temperature and the current that is flowing through the LED string. Such a solution is therefore not compatible with strings that have the same, or similar, operating voltages.

A circuit for dimmable lighting applications according to embodiments is shown in FIG. 4. Circuit 400 comprises a controllable current supply 410, which may be an AC/DC converter supplied from an AC mains input 120 and having first and second current output terminals 141 and 142 and being for supplying current I to a first path 435 or a second path 445. The first path 435 comprises a series arrangement of a switch Sw1 450, a diode D1, and a capacitor C1, the capacitor being arranged to be connected in use in parallel with an LED string 430. The second path 445 comprises a series arrangement of a switch Sw2 460 a diode D2, 460 and a capacitor C2, the capacitor being arranged to be connected in use in parallel with an LED string 440. The first path switch 450 has a first control terminal 452 for receiving a first switching signal 480. The second path switch 460 has a second control terminal 462 for receiving a second switching signal 490. The second switching signal 490 derives from an output of the first switch and is inverted relative to the first switching signal: as shown, the second path switch control terminal 462 is connected to the first path by an optional diode D3 495, such that when the switch Sw1 450 is closed, the control terminal of the second path switch is pulled down. As shown in this embodiment, the second path switch control terminal 462 also connects to the current output terminals 141 and 142 of the controllable current supply 410, by means of a voltage divider comprising first resistor R2a 492 and second resistor R2b 494.

In embodiments—such as that described above with reference to FIG. 4—the drive signal 480 to Switch Sw1 may be obtained from a resistive divider in combination with an optocoupler or transistor. In other embodiments, it is possible to drive Sw1 from a digital driver.

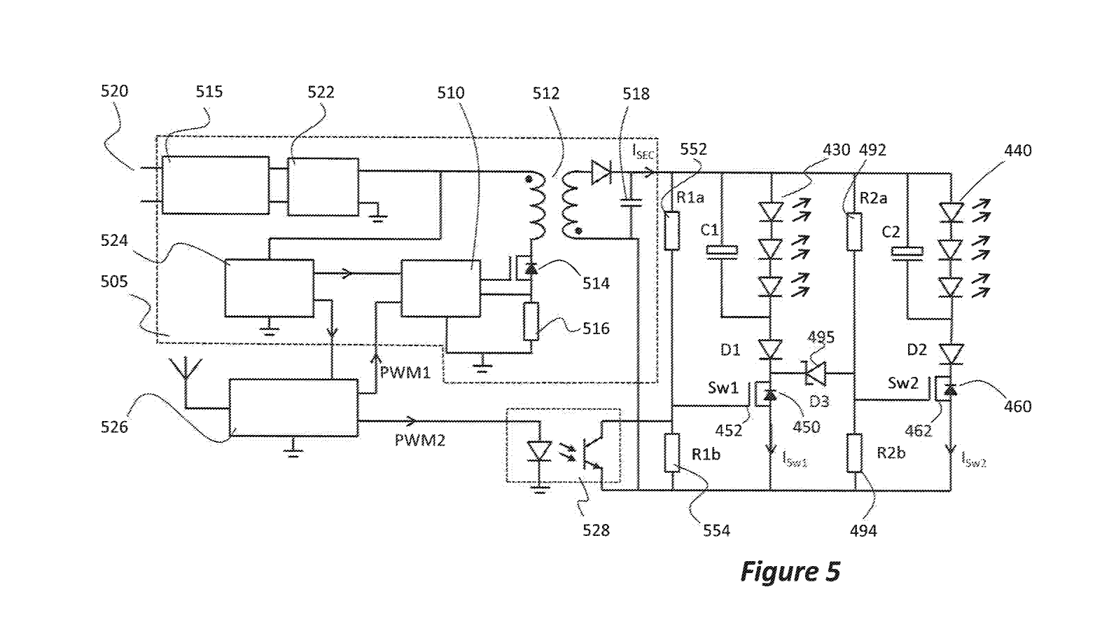

A circuit such as that shown schematically in FIG. 4 is shown in more detail in FIG. 5. The left side of the circuit diagram shows AC mains 520 supplying a rectifier 515 and EMI filter 522. A LED driver 510 configured for flyback operation is powered from a power supply 524. The flyback converter includes a transformer 512 switched by switch 514 under control of the driver 510, a sense resistor 516, and a microcontroller 526. The rectifier, 515, filter 522, power supply 524, driver 510, and converter together may be considered as a controllable current source 505. In the configuration shown the LED strings are isolated from the mains, although in other embodiments that may not be required. The power supply 524 may be used to supply the LED driver 510 and the microcontroller 526 during normal operation, and, further may be configured to supply one or both in standby. In other embodiments, a separate power supply 524 is not required since it is also possible to supply the microcontroller 526 from an auxiliary winding (not shown) on the transformer. As shown, the microcontroller 526 has two PWM outputs: PWM1 is used to control the brightness of the LED lamp while PWM2 controls the colour temperature of the LED lamp. Whereas the outputs may both be pulse width modulated (PWM) outputs as shown, as will be discussed below, other embodiments may instead use other signal types, in particular an analog output comprising an analogue setting may be used for PWM1 to control the LED driver 510. Alternatively and without limitation, other interfaces may be used between the microcontroller and the LED driver, such as 120.

The microcontroller may be adapted to use known lighting control interface standards or protocols, such as DALI (Digital Addressable Lighting Interface), DSI (Digital Serial Lighting), X10, and the like as will be familiar to the skilled person. In other embodiments, the microcontroller may be adapted to use proprietary, or dedicated control protocols. The microcontroller may be configured to wirelessly receive data using WIFI, Bluetooth, Zigbee, or other wireless data transfer protocols, or to receive data over a wired interface.

In operation, the voltage across the secondary coil of the transformer 512 rises very fast when the LED driver 510 starts switching. This voltage is divided by each of the two resistive dividers R1 (552 and 554) and R2 (492 and 494). The switches Sw1 450 and Sw2 460—which are shown as MOSFETs—start to conduct when the voltage across the lower resistors (R1b 554 and R2b 494) of the voltage dividers reaches the respective threshold voltage of these MOSFETs. Because Sw1 450 starts to conduct, the gate voltage of Sw2 460, that is to say the voltage on its control terminal 462, is pulled down via the diode D3 495, which turns off switch Sw2 460. Optional diode D3 may generally be a Schottky diode. Thus, in the final situation first path switch Sw1 450 will be conducting and the first LED string 430 will give light, while second path switch Sw2 460 is not conducting and the second LED string 440 will be off.

If PWM2 is made high, the optocoupler phototransistor starts to conduct, which pulls the control terminal 452, that is to say the gate of the MOSFET shown in this embodiment, of first path switch Sw1 450 low. First path switch Sw1 then opens, that is to say stops conducting, and first LED string 430 is switched off. At this point, the control terminal 462 of second path switch Sw2 460 is no longer pulled down by diode D3 495, so its voltage will rise towards that defined by the voltage divider R2. Second path switch Sw2 460 then starts to conduct, switching on the second LED string 440.

Thus, by switching PWM2 to high or low the secondary side current can be switched from the first LED string to the second LED string, and from the second LED string to the first LED string respectively.

The circuit may include a respective capacitor C1, C2 across one or each of the LED strings 430 and 440. The capacitors may typically be electrolytic capacitors in order to handle the charge and/or voltages involved. They are provided in addition to the converter output capacitor 518, in order to reduce the ripple current: as a result, the current through the LED strings stays more or less constant although the secondary current is switched from one branch to the other. Thus, where included, such capacitors act as a filter to transfer the pulsed current into a more constant current through the LEDs. A constant current may result in a relatively higher lumen per watt/LED efficiency. Additionally, since the light emitted by the LEDs contains less ripple the perceived “quality of light” may be improved. Nonetheless, inclusion of such capacitors would result in increased cost and size. For some applications, for example when the LEDs are OLEDs, the colour temperature may be quite sensitive to the drive current. In such applications adding the capacitors might result in the consequence that, when fading the current, the reproduced colour becomes less predictable.

Although in the embodiment shown in FIG. 5, the first and second string of LEDs are each shown with three LEDs, the skilled person will appreciate that the number of LEDs in each string may differ, and that it is possible to use more, or fewer LEDs. As used herein, the term ‘LED string’ may even extend to just a single LED; in particular, this may be the case where the voltages of LEDs or LED devices differ significantly, as may be the case for true white LEDs.

It will be appreciated that the values chosen for the resistors in the resistive dividers R1 and R2 may depend on the LED string voltage, which in turn depends on the number of LEDs in each string, and the characteristics of the first and second path switches. In particular in embodiments in which the first and second path switches are implemented as MOSFET, this includes their respective maximum gate voltage, threshold voltage and gate capacitance.

It has already been mentioned that diode D3 may not be required in some embodiments. In particular, it has been found experimentally, that in embodiments in which the total string voltage is limited to a maximum of for example 15V and the first and second path switches are implemented as MOSFETs, D3 may not be required and can be omitted. In this case, the gate of second path switch Sw2 460 may be connected directly to the output—which is the drain in the embodiment shown—of first path switch Sw1 450.

In embodiments in which bipolar transistors, which are generally cheaper than MOSFETs switches, are used for the first and second path switches, diode D3 may be required. It will be appreciated that base currents in bipolar transistors are generally higher than gate currents in MOSFETs, and since any base currents would generally represent a loss and may be difficult to handle, MOSFETs may provide more efficient or simpler embodiments.

Further, it has been experimentally found that, in embodiments a resistive divider R2 comprising resistors R2a 492 and R2b 494 may not be required. In particular, it may be replaced by a single pull-up resistor 492. This is particularly the case where the second path switch Sw2 460 is implemented as a MOSFET with sufficiently high gate voltage, such that its gate voltage is not exceeded.

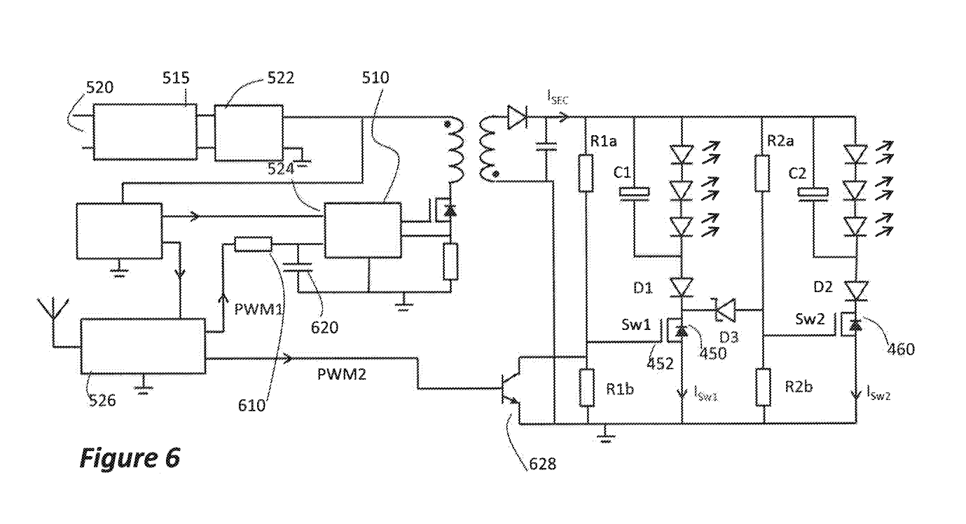

FIG. 6 shows a further embodiment according to an aspect of this disclosure. This embodiment is similar to that shown in FIG. 5; however, in this case, the circuit is a non-isolated flyback converter. Thus this embodiment differs from that shown in FIG. 5 in that the microcontroller 526 is directly coupled to a transistor 628 to pull the control terminal 452 of first path switch Sw1 450 low. Also, in this embodiment are shown resistor 610 and capacitor 620 on the microcontroller 526 output signal line for PWM1, in order to convert the PWM signal generated by the micro controller into a DC voltage at the DIM input of the LED driver that in turn sets the total output current

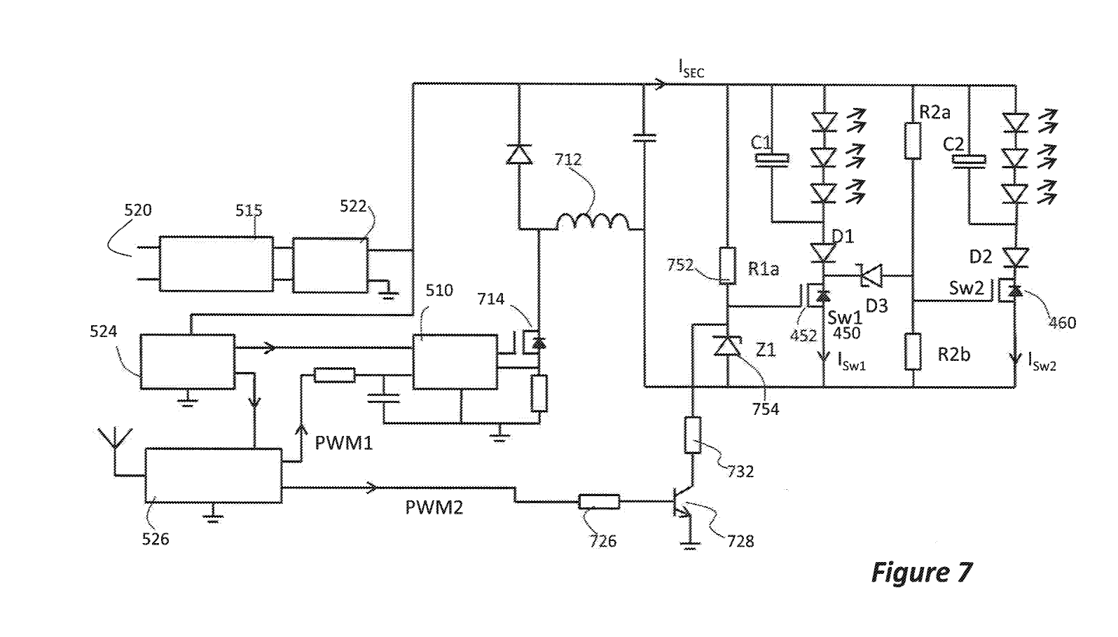

FIG. 7 shows a yet further embodiment according to an aspect of this disclosure. This embodiment is similar to that shown in FIG. 6; however, in this case, the circuit is a non-isolated buck converter. The skilled person will be familiar with the configuration and operation of the inductor 712 and switch 714 in a buck converter as shown. In this embodiment, the control signal PWM2 from the microcontroller does not directly control a transistor (628 in FIG. 6) for pulling the control terminal 452 of first path switch Sw1 450 low. Rather, the PWM2 output is directed, through a current limiting resistor 726, to the control terminal of a switch 728, which as shown may be implemented as a BJT. The output from this switch is connected, via a level-shifting resistor 732, to the control terminal 452 of first path switch Sw1 450. The control terminal of switch 450 is, in this embodiment, connected to the positive output of the current source by pull-up resistor 752, and to the negative output by zener diode 754, in order to ensure that the control terminal is high, such that the switch 450 is on—that is to say the transistor is conducting—when it is not indirectly pulled low due to a high PWM2 signal. The zener diode 754 prevents the gate-source voltage of Sw1 450 from becoming too high or too low.

From consideration of the embodiments shown in FIGS. 5, 6 and 7, the skilled person with appreciate that the first switching signal as received by the first path switch may be a direct copy of the control signal PWM2 that is output from the microcontroller, or may be an inverted copy of it—as shown in FIGS. 5 and 6 and 7.

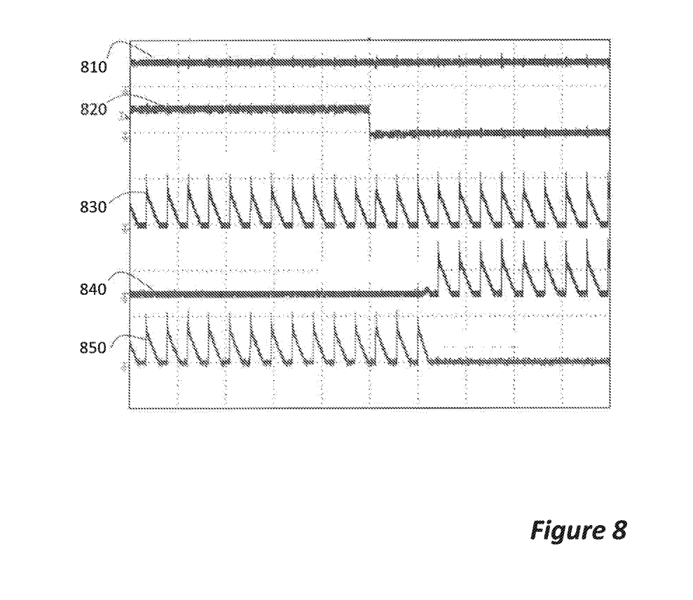

FIG. 8 shows various waveforms associated with the embodiment of FIG. 5, over a part of the switching cycle when the LED driver is providing current (that is say, PWM1 is high). The waveforms are, from the uppermost: the LED driver signal PWM1 810, the colour temperature control signal PWM2 820, the current I 830 through the secondary coil of the transformer, the current 840 through the first path switch Sw1, and the current 850 through the second path switch Sw2. The secondary current is pulsed, at the LED driver frequency, and each pulse has a generally triangular waveform as will be familiar to the person skilled in the field of switch mode converters. As can been seen from the figure, the current through the first path switch is zero whilst the PWM2 signal is high. During this time, there are current pulses the through switch Sw2. The LED current (not shown) is smoothed by the presence of the capacitor C2. Shortly after the PWM2 signal 820 goes low, the current pulses through the second path switch Sw2 stop, and current pulses commence through the first path switch. It will be noted that there is a short delay (which, for a switching frequency of 100 kHz, may be around 24 μs) between PWM2 going low, and the current toggling from the second current path to the first current path. This results from the time taken for the voltage at the control terminal of the first path switch 450 to reach its threshold voltage.

This delay may be compensated, for instance by software in the microcontroller 526, although since generally the delay in toggling from the first path to the second path will match the delay in toggling from the second path to the first path, compensation may not be necessary.

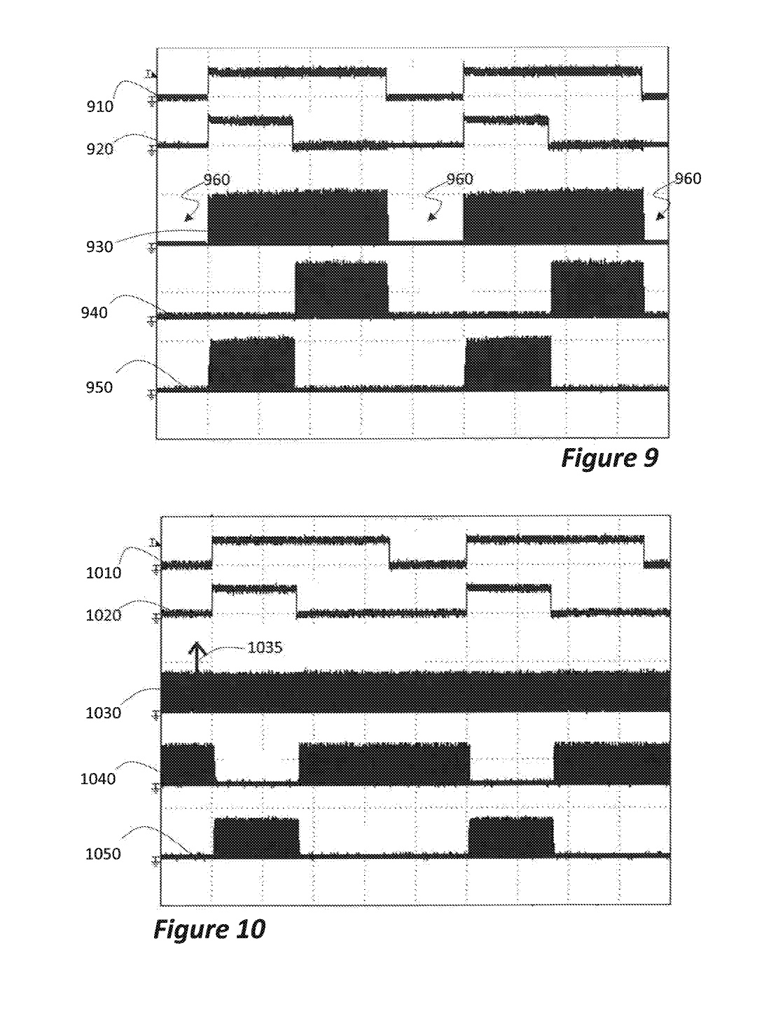

FIG. 9 shows the same waveforms as FIG. 8, but over a longer timeframe or period, for a circuit using pulse width modulation (PWM) dimming for setting the total current. The waveforms are, from the uppermost: the LED driver signal PWM1 910, the colour temperature control signal PWM2 920, the current I 930 through the secondary coil of the transformer, the current 940 through the first path switch Sw1, and the current 950 through the second path switch Sw2. Due to the extended timeframe, the individual switching cycles in the secondary current I are not visible. However, the PWM of the secondary current is clearly shown, there being no secondary current for part 960 of the driver switching period. Consequently, during this part of the cycle there is current through neither the first current path, nor the second current path.

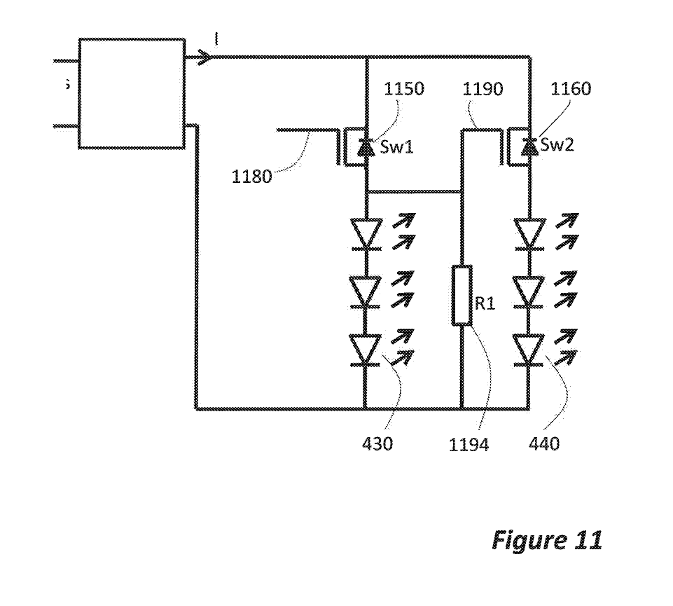

FIG. 10 shows similar waveforms as FIG. 9, but this time for a circuit using analogue dimming. The waveforms are, from the uppermost: the LED driver signal PWM1 1010, the colour temperature control signal PWM2 1020, the current I 1030 through the secondary coil of the transformer, the current 1040 through the first path switch Sw1, and the current 1050 through the second path switch Sw2. Once again, due to the extended timeframe, the individual switches cycles in the secondary current I are not visible. In contrast to the PWM switching case shown in FIG. 9, in this case, the secondary current is continuous—at least on this timescale. The effect of the PWM1 signal 1010 being high for only a part of the cycle is to reduce the amplitude 1035 of the secondary current I 1030. The shorter the mark-space ratio of the PWM1 signal 1010, the lower the average secondary current I 1030. As a result, there is no “off” period 960; instead, one or either (but not both) of the first path switch and the second path switch are closed.

In the embodiments described above, the switches are “low-side” switches. That is to say, the inputs of the switches are connected in common to the negative output of the controllable current supply. In other embodiments, the switches are “high-side” switches. That is to say the inputs of the switches are connected in common to the positive output of the controllable current supply. In general, “low-side switches”—particularly in MOSFET implementation—are less expensive or are more readily available than high-side switches; nonetheless, the present disclosure is not limited to embodiments using low-side switches:

FIG. 11 shows a circuit for dimmable lighting applications, in which current is supplied from a controllable current supply to at most one of two current paths, the current paths each including, in use, a highside switch Sw1 1150, Sw2 1160 in a series arrangement with an LED string. The first switch is driven, in use, by a drive signal 1180. Similarly to the previously described embodiments, the control terminal of the switch in the second path is electrically connected to the output of the switch in the first path, and as a result the switching signal which controls the open/closed switching status of the second switch is inverted relative to the switching signal which controls the open/closed switching status of the first switch; that is to say, when the switching signal on the first switch is high, the switching signal on the second switch is low, and vice versa, so the drive signal 1190 for the second switch is the inverse of the drive signal 1180 for the first switch. As a result, the open/closed switching status of the second path switch is inverted relative to the open/closed switching status of the first path switch. As shown, there may be no capacitor in parallel with one or either of the LED strings; however in other embodiments a capacitor is included to smooth the current through the LED string or strings. Also, there may be no need for a pull up resistor, or a grounding resistor, to control the swing on the control terminal of the second path switch; however in other embodiments one or other of a grounding resistor R1 1194 as shown and a zener diode may be connected between the control terminal of the second path switch and the positive output and negative output of the controllable current source, respectively. Also, as shown, there may be no requirement for a series diodes in one or each of the paths; however, in particular in embodiments in which the voltage across the LED strings differs significantly, a diode may be included in one or each path.

As used herein, the term “LED” or light emitting diode is to be interpreted broadly to encompass all types of LED, such as without limitation crystalline LEDs, and organic or polymer-based LEDs (“OLEDS).

From reading the present disclosure, other variations and modifications will be apparent to the skilled person. Such variations and modifications may involve equivalent and other features which are already known in the art of lighting circuits, and which may be used instead of, or in addition to, features already described herein.

Although the specific embodiments above have been described with reference to changing the colour temperature of “white” LED lighting, the skilled person would appreciate that the invention is not limited thereto. In particular and without limitation, aspects of the present disclosure may be directed towards independent control of the intensity and directionality or focusing of two LED strings. An example may be applications in which quality panoramic lighting is required, and the LEDs are arranged such that the LEDs in the first path are forward facing and the LEDs in the second path are backwards facing, relative intensity being variable. In a further application, combination of two or more such pairs of LED strings, arranged in circular arrangement with the first and second path of each pair being diametrically opposite, may be controlled in order to provide the effect of a rotating beacon. Similarly, aspects of the present disclosure may be useful for LED strings which are both coloured, in order to independently controlled intensity and colour mixing of lighting.

Although the appended claims are directed to particular combinations of features, it should be understood that the scope of the disclosure of the present invention also includes any novel feature or any novel combination of features disclosed herein either explicitly or implicitly or any generalisation thereof, whether or not it relates to the same invention as presently claimed in any claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub-combination. The applicant hereby gives notice that new claims may be formulated to such features and/or combinations of such features during the prosecution of the present application or of any further application derived therefrom.

For the sake of completeness it is also stated that the term “comprising” does not exclude other elements or steps, the term “a” or “an” does not exclude a plurality, a single processor or other unit may fulfil the functions of several means recited in the claims and reference signs in the claims shall not be construed as limiting the scope of the claims.

1. A circuit for dimmable lighting applications, the circuit comprising:
a controllable current supply having a positive output and a negative output and being for supplying current to at most one of a first path and a second path, the first and second path each comprising, in use, a series arrangement of a switch and an LED string;
the first path switch and second path switch each having a respective input, a respective output, and a respective control terminal,
the respective inputs being connected in common to a one of the positive output and the negative output of the controllable current supply, and
an open/closed switching status of each switch being selectable by a respective switching signal at its respective control terminal;
wherein the second path switch control terminal is electrically coupled to the first path switch output such that the second switching signal is inverted relative to the first switching signal.

2. A circuit according to claim 1, further comprising, in the case that the respective inputs are connected in common to the negative output of the controllable current supply, a pull-up resistor, and in the case that the respective inputs are connected in common to the positive output of the controllable current supply, a pull-down resistor, the respective pull-up or pull-down resistor being arranged to electrically connect the second path switch control terminal to the controllable current source positive or negative output respectively.

3. A circuit according to claim 1, further comprising a voltage divider between the positive output and the negative output of the controllable current source and having an intermediate terminal electrically connected to the second path switch control terminal.

4. A circuit according to claim 1, wherein at least one of the first and second path is arranged to further comprise, in use, a capacitor arranged in parallel with the respective LED string.

5. A circuit according to claim 1, wherein at least one of the first and second path further comprises a diode in the series arrangement.

6. A circuit according to claim 1, wherein the second path switch control terminal is directly electrically connected to the output of the first path switch.

7. A circuit according to claim 1, wherein the second path switch control terminal is electrically connected to the switched output of the first path switch by a blocking diode.

8. A circuit according to claim 7, wherein the first path switch and the second path switch each comprise a bipolar transistor, and wherein the blocking diode is a schottky diode.

9. A circuit according to claim 1, further comprising a microcontroller configured to provide at least one of the first switching signal and an average current supply control signal.

10. A circuit according to claim 9, wherein the microcontroller is configured to control the current supply by pulse width modulation.

11. A circuit according to claim 9, further comprising an optocoupler arranged between the first switch control terminal and the microcontroller for isolating the first switch control terminal therefrom.

12. A circuit according to claims 9, wherein the microcontroller is configured to receive a colour temperature control signal, and to determine the first switching signal in dependence on the colour temperature control signal.

13. A circuit according claim 9, wherein the microcontroller comprises a wireless receiver configured to receive at least the colour temperature control signal wirelessly.

14. A circuit according to claim 1, further comprising an LED string in each of the first and second path.

15. A lighting unit, comprising a circuit as claimed in claim 1, housed in a luminaire.
